(19) United States
(12) Patent Application Publication
(10) Pub. No.: US 2014/0317523 A1
(43) Pub. Date: Oct. 23, 2014

(54) USER EXPERIENCE MODE TRANSITIONING

(71) Applicant: MICROSOFT CORPORATION, Redmond, WA (US)

(72) Inventors: Timothy Wantland, Bellevue, WA (US); Ryan Fedyk, Seattle, WA (US); Pasquale DeMaio, Bellevue, WA (US)

(73) Assignee: Microsoft Corporation, Redmond, WA (US)

(21) Appl. No.: 13/866,668

(22) Filed: Apr. 19, 2013

(51) Int. Cl. H04L 29/08

(52) U.S. Cl. CPC H04L 67/22
USPC 715/744

(57) ABSTRACT

One or more techniques and/or systems are provided for transitioning between user experience modes. That is, a device may comprise a computing environment (e.g., an operating system, a social network application, a user interface, a communication application, etc.). A first user experience mode may be applied to the computing environment based upon interaction by a first user (e.g., text may be displayed in English, a first email account of the first user may be provided, a high contrast display mode may be applied, etc.). Responsive to detecting transfer of the device to a second user (e.g., the first user may rotate the device towards the second user), the computing environment may be transitioned to a second user experience mode (e.g., text may be displayed in French, an email application may be logged out of the first email account and into a second email account of the second user, etc.).

### BACKGROUND

Many users may share, communicate, and/or collaborate through a device, such as a tablet device, a mobile device, a laptop, and/or any other type of computing device. In an example, a first user may access an email account, a social network, and/or other information associated with the first user through a tablet device. A second user, such as a spouse of the first user, may utilize the same tablet device to access an email account, a social network, and/or other information associated with the second user. The first user and the second user may either share a user experience mode (e.g., operating system display settings, web browser preferences, folders, saved password settings, etc.) or may logout and login between different user experience modes (e.g., user accounts setup through the operating system), which may result in an interruptive experience when the first user “hands off” the tablet device to the second user. In another example, a first user, fluent in a first language, may attempt to communication with a second user, fluent in a second language, using a translation website or application hosted by a device. Because the device may be unaware of interactions between the first user, the second user, and/or the device, a user may have to explicitly input a command to perform a language translation of text and/or change an input mode of the device (e.g., the first user may prefer voice input, while the second user may prefer touch input).

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for transitioning between user experience modes are provided herein. That is, a first user may interact with a device (e.g., the first user may be viewing, holding, and/or inputting information into a tablet device). During interaction with the device, a first user experience mode may be applied to a computing environment hosted by the device (e.g., an operating system, a communication application, an email application, a social network application, etc.). For example, a user interface theme (e.g., a background picture, sound settings, color settings, font size, a high contrast mode, etc.), a setting of the computing environment (e.g., web browser saved password settings, web browser settings, application settings, etc.), language settings (e.g., language translation functionality), input device type (e.g., a particular keyboard, a mouse scroll setting, voice commands, touch commands, etc.), logging into a user account (e.g., an email account, a social network account, a market place account such as an e-commerce website, a multimedia streaming account such as a video streaming service, etc.), and/or other settings associated with the first user may be applied to the computing environment.

A transfer of the device from the first user to a second user may be detected. In an example, device transfer motion of the device may be detected as the transfer (e.g., the first user may initially hold the device facing the first user, and then the first user may rotate/flip the device towards the second user resulting in the device facing the second user as opposed to the first user). In another example, a change in voice pattern may be detected as the transfer (e.g., a microphone on a front portion of the device may detect a voice of the first user as a primary input, such that when the device is transferred to the second user, the microphone may detect a voice of the second user as the primary input). In another example, a change in facial recognition from the first user to the second user may be detected as the transfer (e.g., using a camera of the device). It may be appreciated that various detection techniques (e.g., a change in biometric information, such as by an infrared component of the device) and/or components may be used to identify the transfer of the device from the first user to the second user.

Responsive to detecting the transfer, the computing environment may be transitioned from the first user experience mode to a second user experience mode. In an example where the computing environment comprises a communication application, the communication application may be transitioned into a second language (e.g., text, inputted by the first user in a first language, may be translated into the second language based upon voice recognition of the second language of the second user; a user interface of the communication application may be displayed in the second language; etc.) and/or into a second communication input type (e.g., the communication application may be switched from a voice input mode, preferred by the first user, to a touch input mode, preferred by the second user, based upon the second user attempting to type through touch input or based upon a user profile associated with the second user). In an example where the computing environment comprises an email application, the email application may be logged out of a first email account of the first user, and may be logged into a second email account of the second user. In an example where the computing environment comprises a social network application, the social network application may be logged out of a first social network account of the first user, and may be logged into a second social network account of the second user. It may be appreciated that the second user experience mode may specify a variety of settings, accounts, and/or other information associated with the second user (e.g., a user interface theme, a high contrast view mode, sound settings, input device types, etc.).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of transitioning between user experience modes.

FIG. 2 is an illustration of an example of a first user transferring a device to a second user.

FIG. 3 is an illustration of an example of a first user transferring a device to a second user.

FIG. 4 is an illustration of an example of a first user transferring a device to a second user.

FIG. 5 is a component block diagram illustrating an exemplary system for transitioning between user experience modes.

FIG. 6 is a component block diagram illustrating an exemplary system for transitioning between user experience modes.

FIG. 7 is a component block diagram illustrating an exemplary system for transitioning between user experience modes.

FIG. 8 is a flow diagram illustrating an exemplary method of transitioning a communication application between user experience modes.

FIG. 9 is a component block diagram illustrating an exemplary system for transitioning a communication application between user experience modes.

FIG. 10 is an illustration of an exemplary computer readable medium wherein processor-executable instructions configured to embody one or more of the provisions set forth herein may be comprised.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

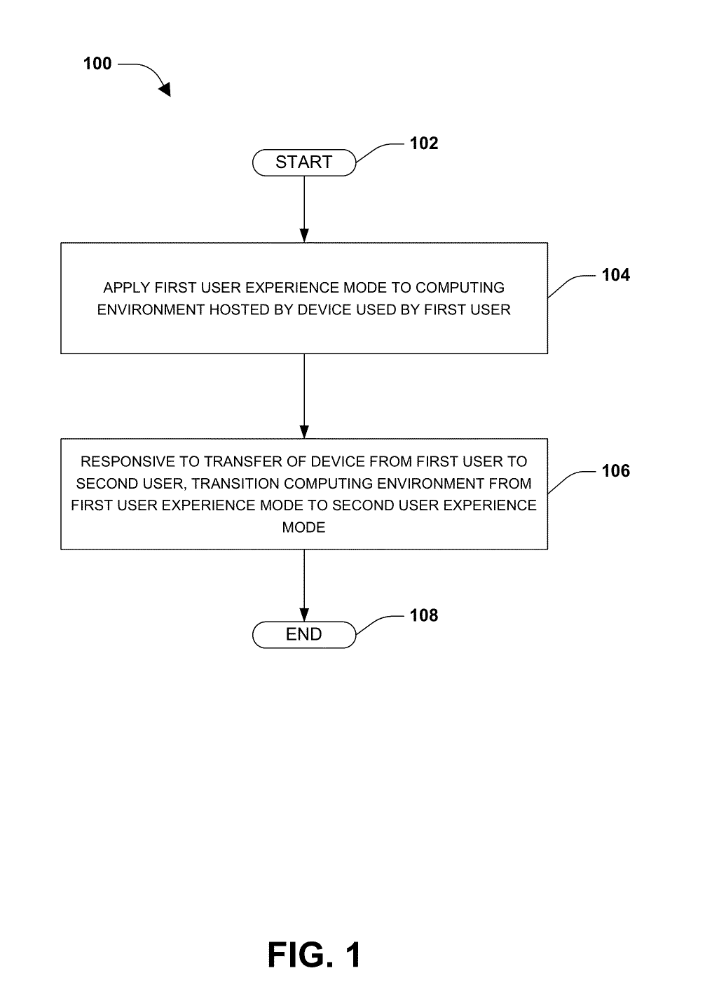

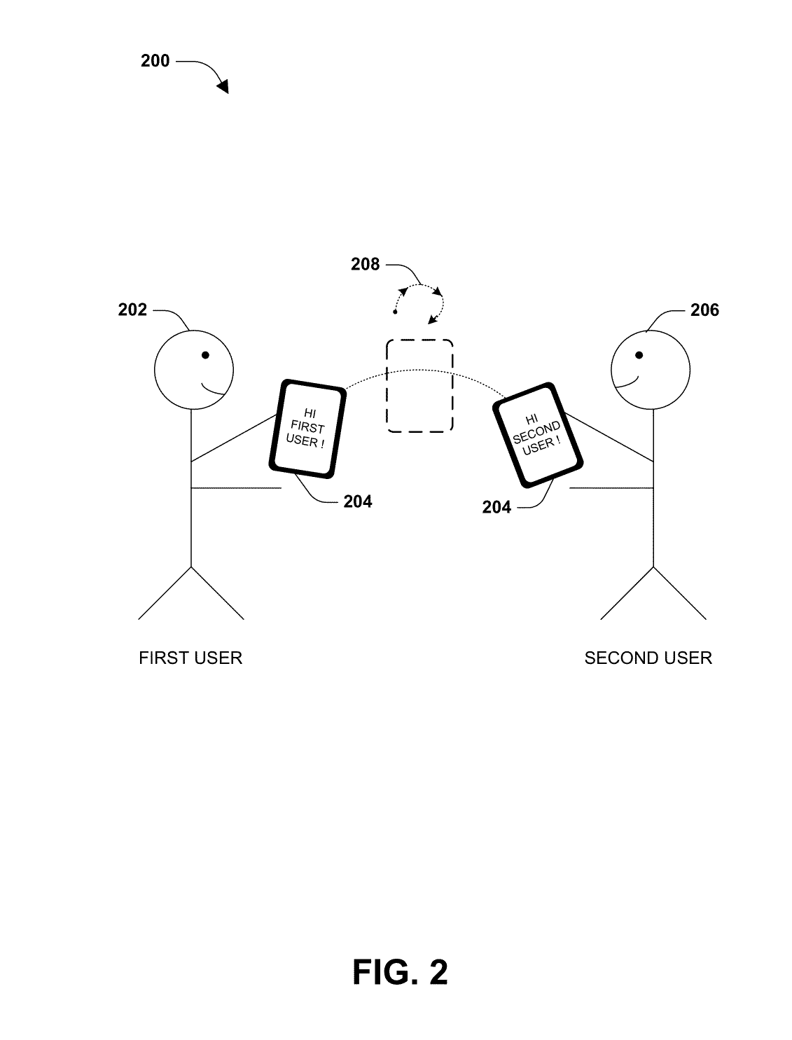

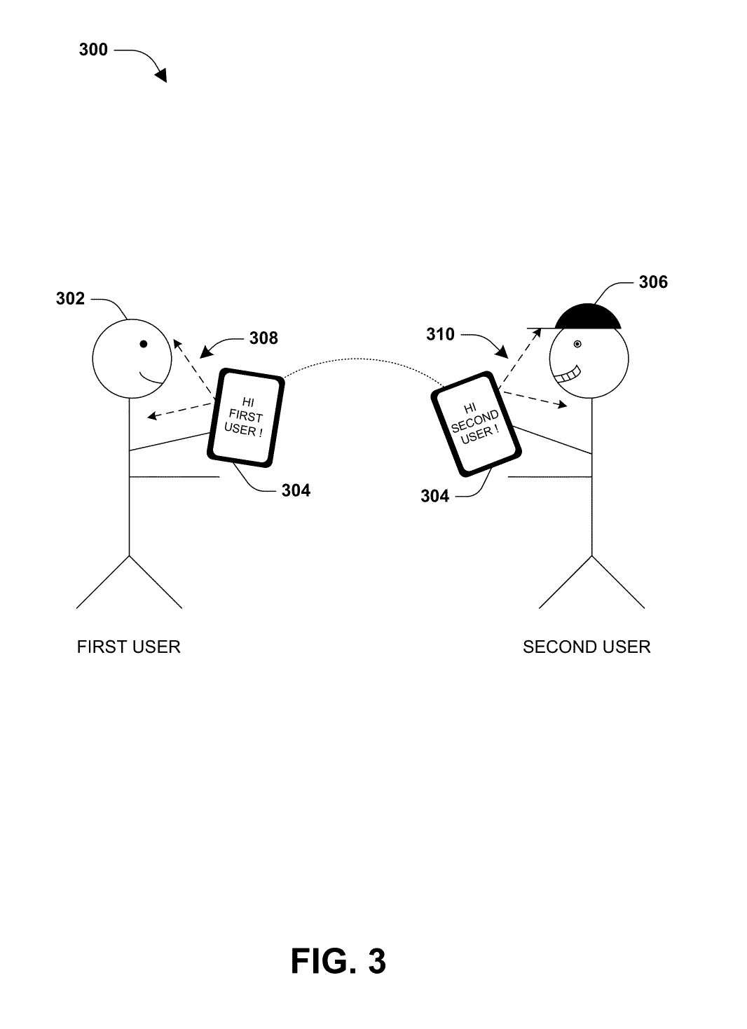

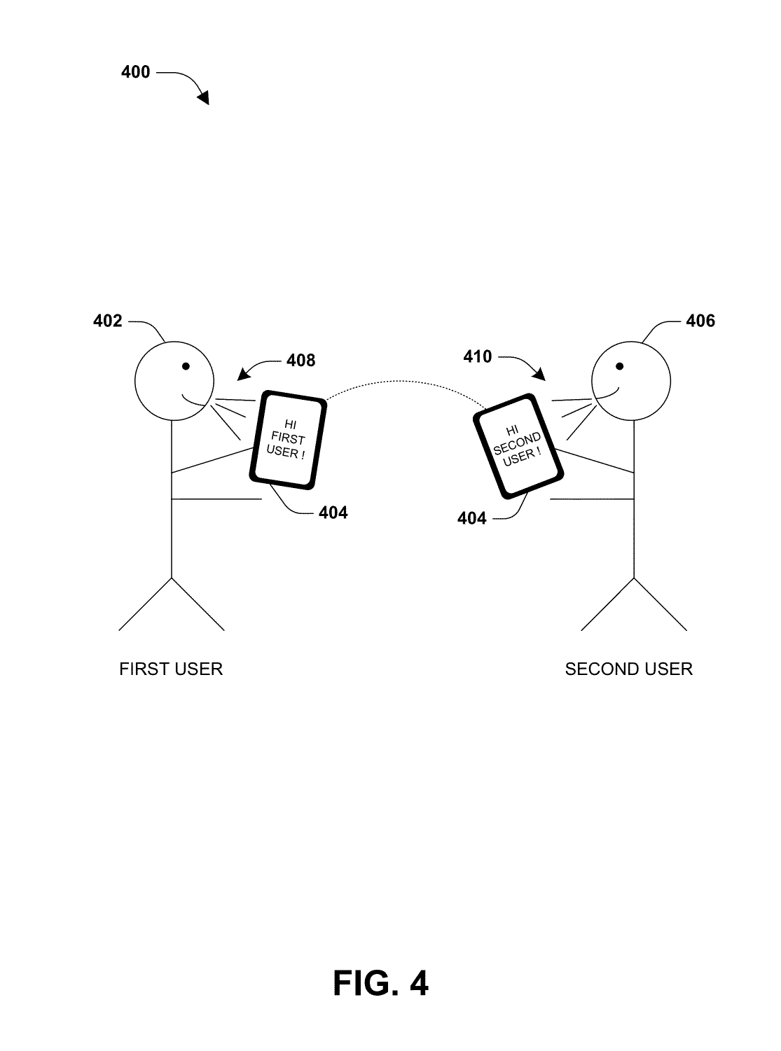

An embodiment of transitioning between user experience modes is illustrated by an exemplary method 100 of FIG. 1. At 102, the method starts. In an example, a first user and a second user may share, communicate through, collaborate through, and/or otherwise interact through a device, such as a tablet device. At 104, a first user experience mode may be applied to a computing environment hosted by the device user by the first user. For example, the first user experience mode may be applied based upon determining that the first user is interacting with the device (e.g., based upon a voice pattern of the first user, a login of the first user, facial recognition of the first user, biometric information of the first user, the first user experience mode being a default mode, etc.). Responsive to detecting transfer of the device from the first user to a second user (e.g., FIGS. 2-4), the computing environment may be transitioned from the first user experience mode to a second user experience mode at 106. In an example of detecting the transfer, the transfer of the device may be detected based upon device transfer motion of the device such as a flipping motion (e.g., FIG. 2), a change in facial recognition from the first user to the second user (e.g., FIG. 3), a change in voice pattern from the first user to the second user (e.g., FIG. 4), a change in biometric information (e.g., infrared), etc.

In an example of transitioning the computing environment, a user interface theme may be modified (e.g., a background picture, a color scheme, a high contrast setting, a sound theme, a font size, an icon size, and/or a variety of other UI settings may be modified for the second user). In another example, a first user account, associated with the first user, may be logged out of (e.g., an email account, a social network account, a market place account, a multimedia streaming account, etc.), and a second user account, associated with the second user, may be logged into. In another example, textual information, provided through the device, may be translated from a first language (e.g., associated with the first user) to a second language associated with the second user. In another example, an input device type (e.g., preferred by the first user, such as voice input), may be switched to a second input device type preferred by the second user (e.g., touch input). It may be appreciated that merely a few examples of transitioning the computing environment to the second user experience mode are provided, and that other settings, accounts, and/or information may be modified. In some embodiments, the computing environment is automatically transitioned from the first user experience mode to the second user experience mode without user input (e.g., without the first user inputting a first user input command, without the second user inputting a second user input command such as a translate text command, etc.).

In some embodiments, supplemental content may be provided through the computing environment based upon the transition. In an example, a communication context between the first user and the second user may be identified (e.g., the first user may type “Hi, I am traveling abroad to your country, and my son needs medicine X”, and may then transfer the device to the second user to read a translated version of the text; the first user may navigate to a particular photo provided by a photo sharing website, and may then transfer the device to the second user to view the photo; the first user may navigate to a web page describing a particular car of interest to the first user, and may then transfer the device to the second user to view the web page; etc.). Supplemental content may be obtained based upon the communication context. For example, the supplemental content may comprise an image of medicine X, a website describing content of the photo, a video review of the car, and/or a variety of other visual, textual, and/or audio content that may be relevant to the communication context (e.g., an image, a textual description, search results, a video, information extracted from a user email account, information extracted from a user social network account, information extracted from a user calendar, a map, driving directions, and/or other information (e.g., information associated with an entity identified from the computing environment, such as a person entity, a place entity, a business entity, or an object entity)).

It may be appreciated that the computing environment may be transitioned between various user experience modes based upon subsequently detected transfer of the device. For example, responsive to detecting transfer of the device from the second user to the first user, the computing environment may be transitioned from the second user experience mode to the first user experience mode. In another example, responsive to detecting transfer of the device from the second user to a third user, the computing environment may be transitioned from the second user experience mode to a third user experience mode associated with the third user. In some embodiments, a user experience mode may be based upon a user profile of a user (e.g., a user may have previously specified a preferred input type, a high contrast view mode, a font size, an email account login, etc.). In some embodiments, a user experience mode may be based upon detected environmental factors (e.g., a current location of the device, a detected language spoken by a user, visual environmental features detect by a camera of the device, information inputted by the first user and/or the second user, user calendar information such as a meeting notice corresponding to a current time, user email information such as an email regarding a lunch date corresponding to the current time, temporal information, and/or a variety of other information). At 108, the method ends.

FIG. 2 illustrates an example 200 of a first user 202 transferring a device 204 to a second user 206. That is, the first user 202 may interact with the device 204, such as a mobile phone. A first user experience mode may be applied to the device based upon the first user 202 interacting with the device 204 (e.g., the first user 202 having possession of the device 204). The first user 202 may transfer the device 204 to the second user 206. For example, the device 204 may be initially facing the first user 202, and may be rotated (e.g., a flipping motion 208) from the first user 202 to the second user 206 such that the device 204 is facing the second user 206. Based upon detecting the transfer of the device 204 (e.g., detecting the flipping motion 208 utilizing a motion sensing component of the device 204, such as a gyroscope, etc.), a second user experience mode may be applied to the computing environment.

FIG. 3 illustrates an example 300 of a first user 302 transferring a device 304 to a second user 306. That is, the first user 302 may interact with the device 304, such as a mobile phone. A first user experience mode may be applied to the device based upon the first user 302 interacting with the device 304. For example, interaction (e.g., the first user 302 having possession of the device 304) by the first user 302 may be detected based upon a first facial recognition 308 of the first user 302. The first user 302 may transfer the device 304 to the second user 306. The transfer may be detected based upon a change in facial recognition from the first facial recognition 308 of the first user 302 to a second facial recognition 310 of the second user 306. Based upon detecting the transfer of the device 304 (e.g., detecting the change in facial recognition by a camera component of the device 304), a second user experience mode may be applied to the computing environment.

FIG. 4 illustrates an example 400 of a first user 402 transferring a device 404 to a second user 406. That is, the first user 402 may interact with the device 404, such as a mobile phone. A first user experience mode may be applied to the device based upon the first user 402 interacting with the device 404. For example, interaction by the first user 402 (e.g., the first user 402 having possession of the device 404) may be detected based upon a first voice recognition 408 of the first user 402. The first user 402 may transfer the device 404 to the second user 406. The transfer may be detected based upon a change in voice recognition from the first voice recognition 408 of the first user 402 to a second voice recognition 410 of the second user 406. Based upon detecting the transfer of the device 404 (e.g., detecting the change in voice recognition by a microphone component of the device 404), a second user experience mode may be applied to the computing environment. It is to be appreciated that any one or more of the examples provided herein (e.g., FIG. 2, FIG. 3, FIG. 4) may be implemented alone or in combination with one another and/or with other examples, scenarios, etc. That is, the instant application, including the scope of the appended claims, is not to be limited to the examples provided herein.

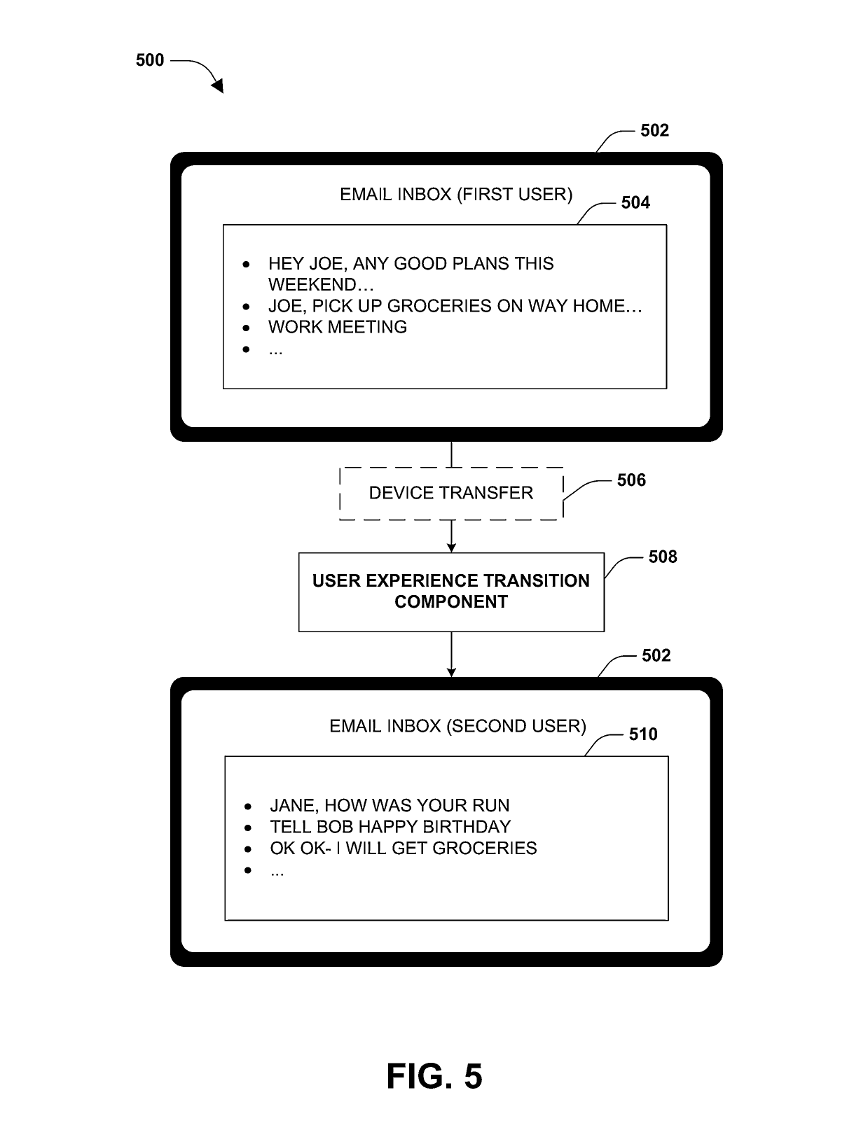

FIG. 5 illustrates an example of a system 500 configured for transitioning between user experience modes. The system 500 comprises a user experience transition component 508 associated with a device 502. In an example, the user experience transition component 508 may have applied a first user experience mode to a computing environment, such as an email application, of the device 502 based upon detecting a first user interacting with the device 502 (e.g., user input; physical possession of the device 502; physical proximity to the device 502; etc.). For example, the user experience transition component 508 may log the first user into a first email account associated with the first user, and may provide a first user email inbox 504 through the email application (e., the first user email inbox 504 may comprise one or more messages associated with the first user—Joe).

The user experience transition component 508 may be configured to detect a device transfer 506 of the device 502 from the first user to a second user. Responsive to detecting the transfer, the user experience transition component 508 may apply a second user experience mode to the computing environment, such as the email application, of the device 502. For example, the user experience transition component 508 may logout the first user from the first email account, and may log the second user into a second email account associated with the second user. In this way, a second user email inbox 510 may be provided through the email application (e.g., the second user email inbox 510 may comprise one or more messages associated with the second user-Jane).

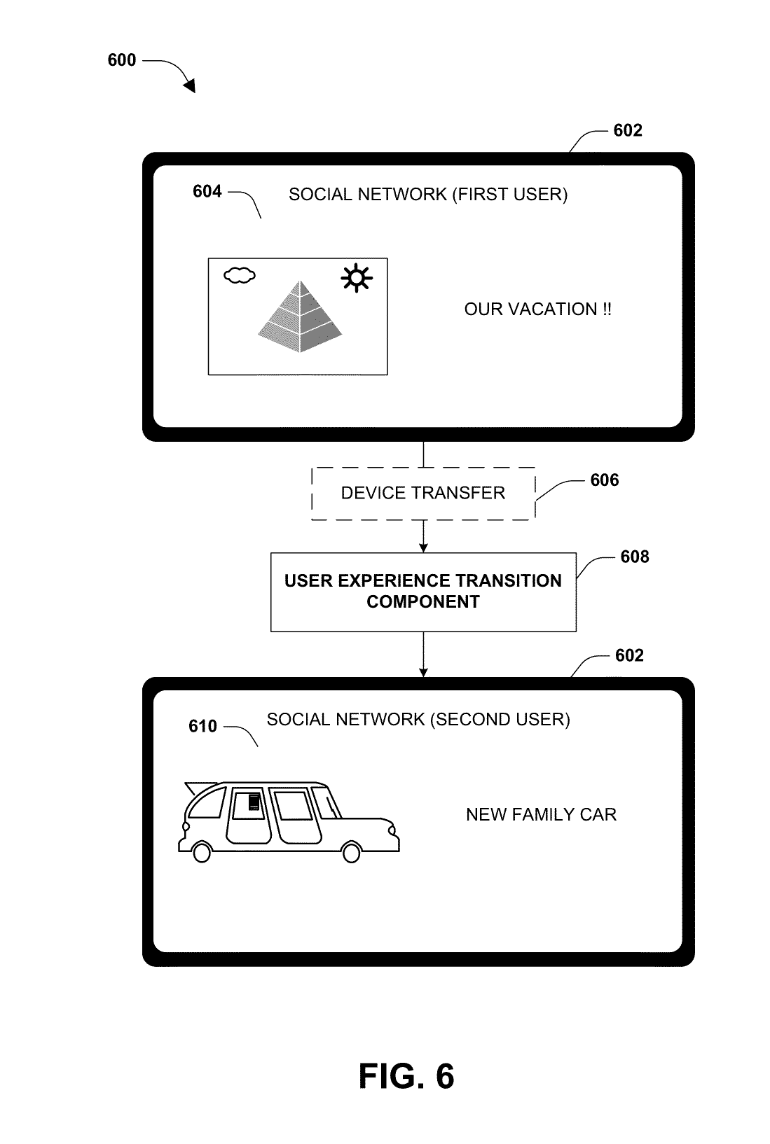

FIG. 6 illustrates an example of a system 600 configured for transitioning between user experience modes. The system 600 comprises a user experience transition component 608 associated with a device 602. In an example, the user experience transition component 608 may have applied a first user experience mode to a computing environment, such as a social network application or website, of the device 602 based upon detecting a first user interacting with the device 602 (e.g., user input; physical possession of the device 602; physical proximity to the device 602; etc.). For example, the user experience transition component 608 may log the first user into a first social network account associated with the first user, and may provide access to first social network information 604 associated with the first social network account (e.g., the first social network information 604 may comprise a vacation image and textual description posted by the first user).

The user experience transition component 608 may be configured to detect a device transfer 606 of the device 602 from the first user to a second user. Responsive to detecting the transfer, the user experience transition component 608 may apply a second user experience mode to the computing environment, such as the social network application or website, of the device 602. For example, the user experience transition component 608 may logout the first user from the first social network account, and may log the second user into a second social network account associated with the second user. In this way, second social network information 610 may be provided through the social network application or website (e.g., the second social network information 610 may comprise a car image and textual description posted through a news feed by a friend of the second user).

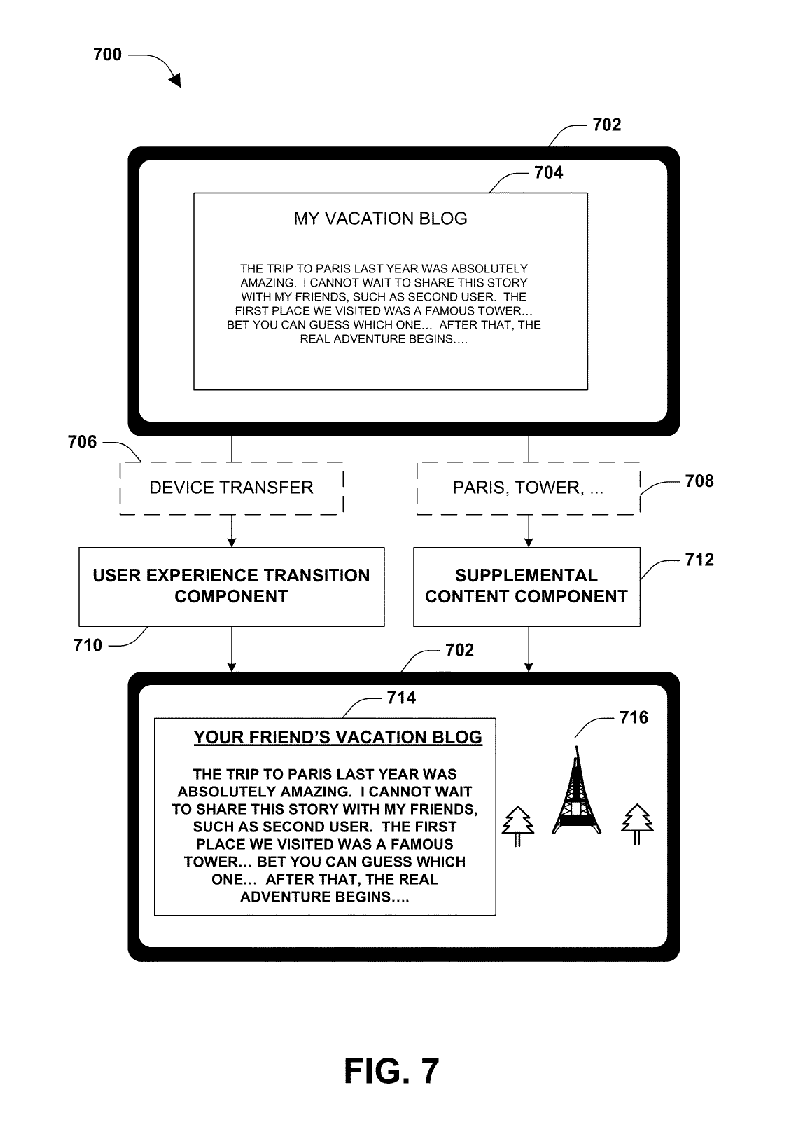

FIG. 7 illustrates an example of a system 700 configured for transitioning between user experience modes. The system 700 comprises a user experience transition component 710 associated with a device 702. In an example, the device 702 may comprise a computing environment, such as an operating system, configured to connect to a blog service. For example, the first user may create a vacation blog 704 through a blog service. The first user may transfer the device 702 to a second user so that the second user may view the vacation blog 704. The user experience transition component 710 may be configured to detect a device transfer 706 of the device 702 from the first user to the second user. The user experience transition component 710 may be configured to apply a second user experience mode to the computing environment of the device 702. For example, the user experience transition component 710 may increase a font size and/or apply a bold font format to a display setting of the operating system (e.g., thus resulting in an increased font size and bold font format of the vacation blog 704, as illustrated by vacation blog 714). The user experience transition component 710 may modify a heading of the vacation blog 704 from “my vacation blog” associated with the first user to “your friend's vacation blog”, as illustrated by vacation blog 714, because the second user is viewing the vacation blog of the first user.

In an example, the system 700 comprises a supplemental content component 712. The supplemental content component 712 may be configured to identify an entity (e.g., entity data 708) associated with the computing environment. For example, a Paris entity, a tower entity, and/or a variety of other visually and/or textually identifiable entities may be extracted from the computing environment, such as from the vacation blog 704. The supplemental content component 712 may identify supplemental content 716 associated with the entity data 708. For example, a Paris tower image may be displayed when the device 702 is transferred to the second user. It may be appreciated that a plethora of supplemental content may be identified and/or provided at various times during user of the device 702 (e.g., real-time directions from a current location of the second user to the Paris tower may be provided; web search results associated with the entity data 708 may be provided; social network data of the first user regarding the vacation may be provided; etc.).

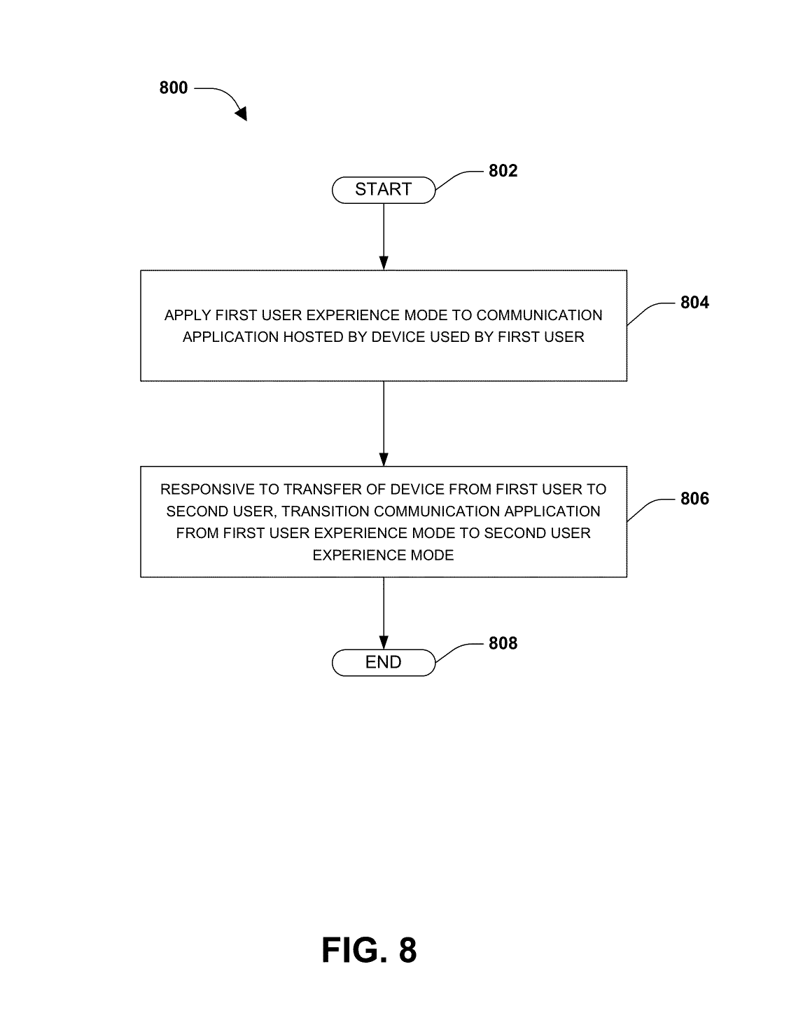

An embodiment of transitioning a communication application between user experience modes is illustrated by an exemplary method 800 of FIG. 8. At 802, the method starts. In an example, a device may host a communication application. The communication application may comprise a text editor application, a translation application, a mobile app, a website, an email application, an instant message application, a textual user interface, and/or any other type of application that may utilize text (e.g., display information as text). At 804, a first user experience mode may be applied to the communication application. The first user experience mode may specify a first language (e.g., textual information, displayed by the communication application, may be formatted according to the first language utilized by the first user) and/or a first communication input type (e.g., the first user may prefer to use touch input when inputting information into the communication application) associated with the first user.

At 806, responsive to detecting transfer of the device from the first user to a second user. The communication application may be transitioned from the first user experience mode to a second user experience mode. The second user experience mode may specify a second language (e.g., textual information, displayed by the communication application, may be translated from the first language to the second language based upon voice recognition of the second user utilizing the second language) and/or a second communication input type (e.g., the second user may start speaking voice commands to the communication application) associated with the second user. At 808, the method ends.

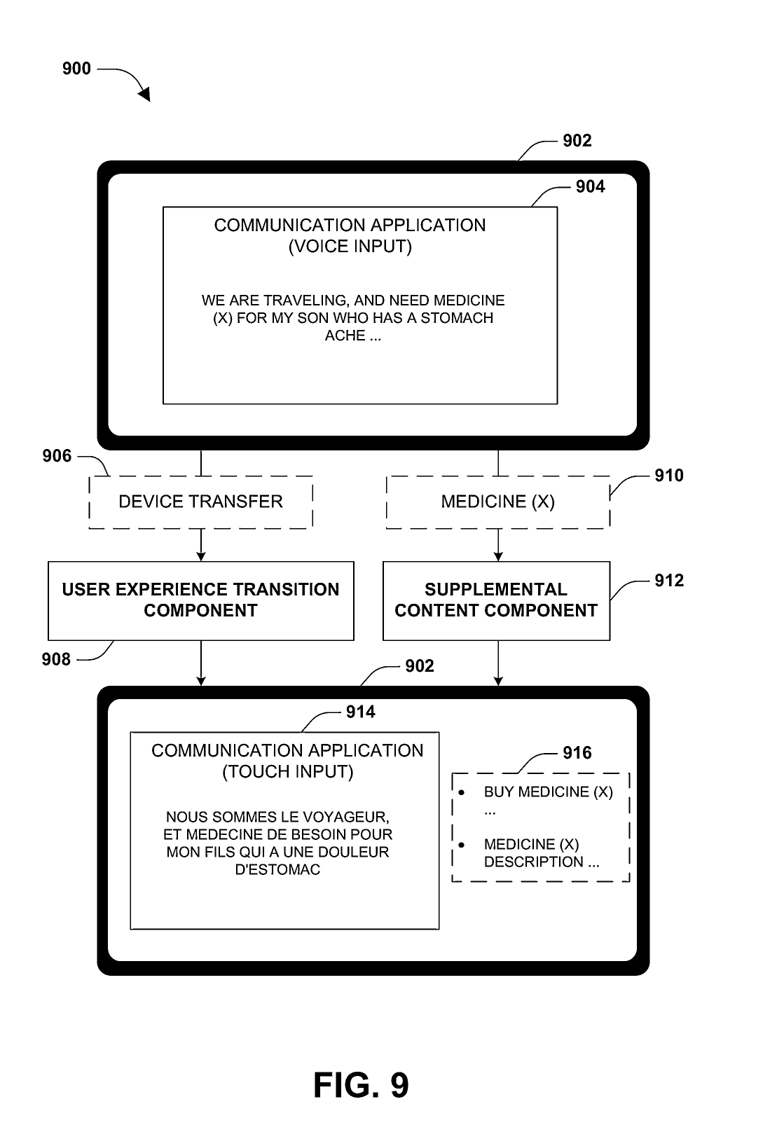

FIG. 9 illustrates an example of a system 900 configured for transitioning a communication application between user experience modes. In an example, a device may host a communication application, such as a translation application. The system 900 may comprise a user experience transition component 908. The user experience transition component 908 may apply a first user experience mode to the communication application based upon user interaction with the device 902 by a first user (e.g., user input; physical possession of the device 902; physical proximity to the device 902; etc.). For example, a voice input mode and an English language format may be applied to the communication application, as illustrated by communication application 904. The user experience transition component 908 may detect a device transfer 906 of the device 902 from the first user to a second user (e.g., the first user may be traveling in France, and may input a question into the communication application for a pharmacist to whom the first user hands the device 902). Responsive to detecting the device transfer 906 (e.g., based upon a primary voice recognition, detected by a microphone of the device 902, switching from the first user speaking in English to the pharmacist speaking in French and/or based upon the pharmacist attempting to touch the device 902 in order to input a response to the question), a second user experience mode may be applied to the communication application. For example, the question may be translated into French (e.g., based upon the pharmacist speaking in French) and/or a touch input mode may be applied (e.g., a French virtual keyboard may be displayed on the device 902 based upon the pharmacist touching a screen of the device 902), as illustrated by communication application 914.

In an example, the system 900 comprises a supplemental content component 912. The supplemental content component 912 may be configured to identify an entity 910, such as “medicine (X)”, associated with the communication application (e.g., based upon textual features extracted from a conversation between the first user and the pharmacist). The supplemental content component 912 may identify supplemental content 916 based upon the entity 910. In an example, the supplemental content 916 may provide a link to a pharmacy website that sells the medicine (X). In another example, the supplement content 916 may provide additional information about the medicine (X). In this way, the first user (e.g., a traveler speaking English) and the second user (e.g., the pharmacist speaking French) may efficiently and/or transparently (e.g., without requiring user input to invoke translations between English and French) communicate through the communication application. In an example, a conversation log may be created based upon the conversation. For example, the conversation log may provide access to the conversation in any language and/or may comprise the supplemental content, such as the supplemental content 916, provided during the conversation. In this way, a user, such as the first user, may access the conversation and/or supplemental content at a later point in time through the conversation log (e.g., the conversation log may be stored on the device 902, stored in cloud storage, accessible through a conversation website, emailed to a user, etc.).

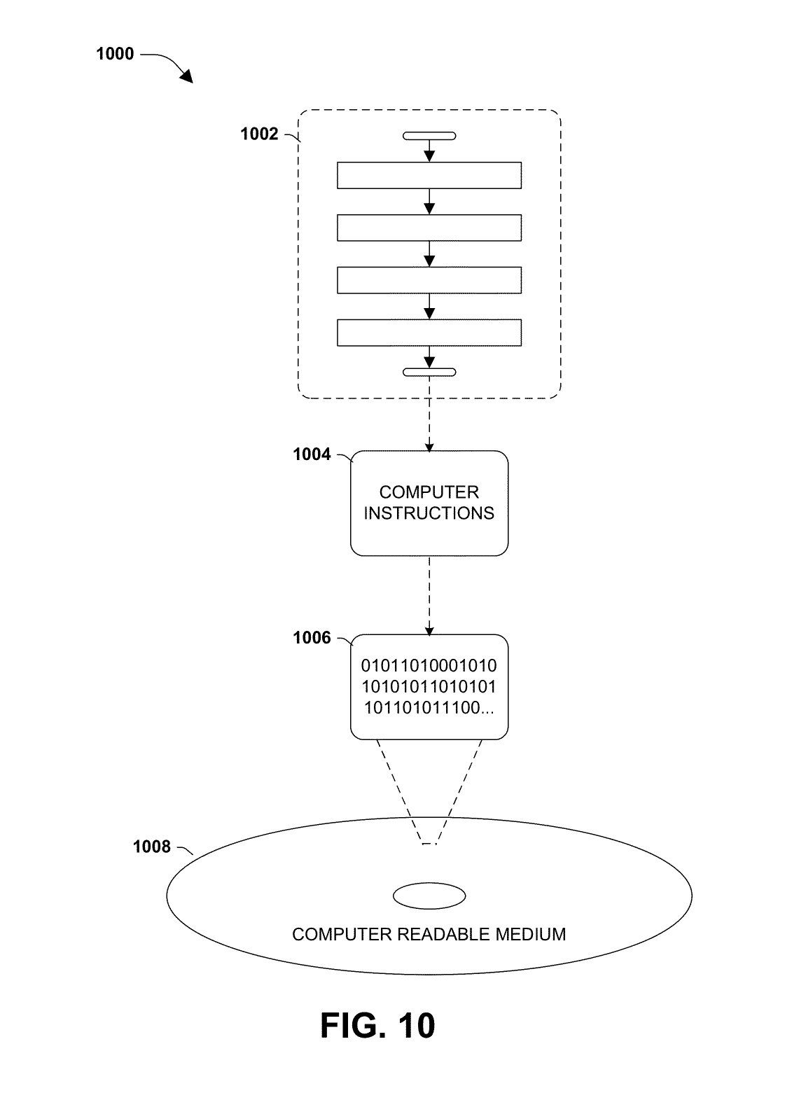

Still another embodiment involves a computer-readable medium comprising processor-executable instructions configured to implement one or more of the techniques presented herein. An example embodiment of a computer-readable medium or a computer-readable device that is devised in these ways is illustrated in FIG. 10, wherein the implementation 1000 comprises a computer-readable medium 1008, such as a CD-R, DVD-R, flash drive, a platter of a hard disk drive, etc., on which is encoded computer-readable data 1006. This computer-readable data 1006, such as binary data comprising at least one of a zero or a one, in turn comprises a set of computer instructions 1004 configured to operate according to one or more of the principles set forth herein. In some embodiments, the processor-executable computer instructions 1004 are configured to perform a method 1002, such as at least some of the exemplary method 100 of FIG. 1 and/or at least some of the exemplary method 800 of FIG. 8, for example. In some embodiments, the processor-executable instructions 1004 are configured to implement a system, such as at least some of the exemplary system 500 of FIG. 5, at least some of the exemplary system 600 of FIG. 6, at least some of the exemplary system 700 of FIG. 7, and/or at least some of the exemplary system 900 of FIG. 9, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

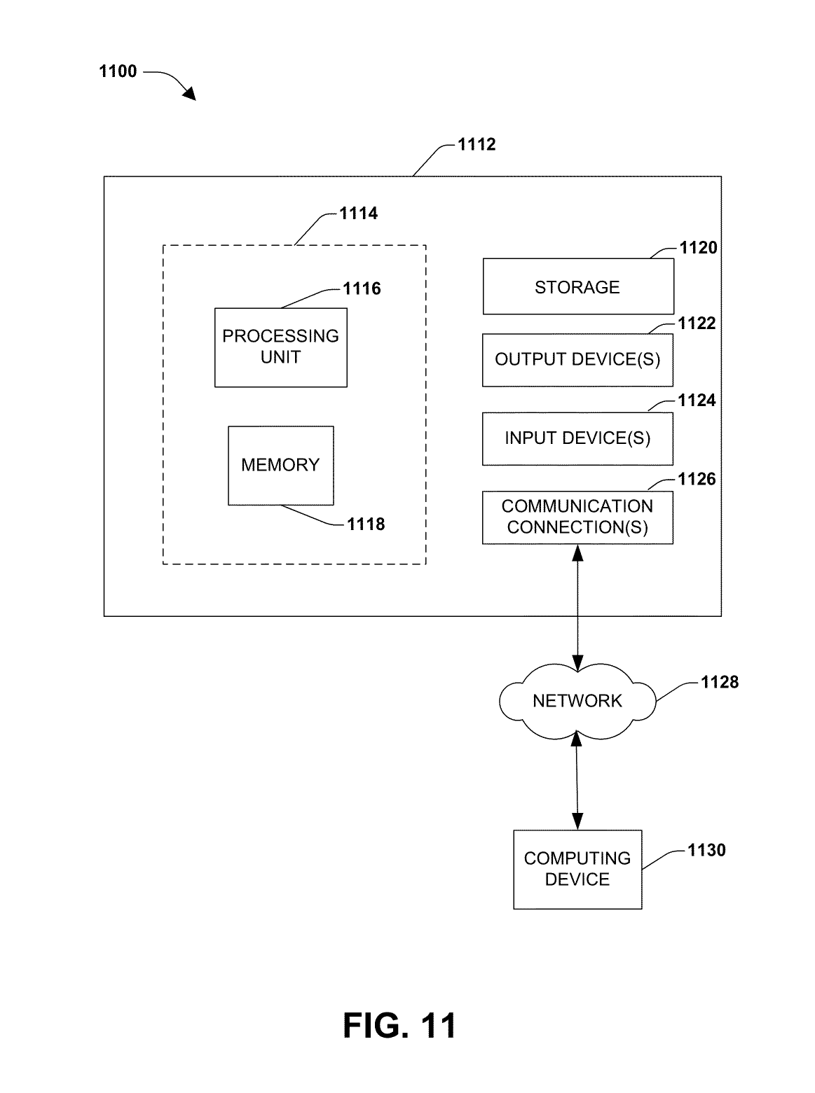

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1100 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 13104), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via a network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application.

What is claimed is:

1. A method for transitioning between user experience modes, comprising:
applying a first user experience mode to a computing environment hosted by a device used by a first user; and
responsive to detecting transfer of the device from the first user to a second user, transitioning the computing environment from the first user experience mode to a second user experience mode.

2. The method of claim 1, comprising:
detecting transfer of the device based upon at least one of:
detecting device transfer motion of the device;
identifying a change in voice pattern from the first user to the second user;
identifying a change in facial recognition from the first user to the second user; or
detecting a change in biometric information from the first user to the second user.

3. The method of claim 1, the transitioning the computing environment comprising at least one of:
modifying a user interface theme;
modifying a setting of the computing environment;
modifying a language setting;
modifying an input device type;
logging out of a first user account associated with the first user; or
logging into a second user account associated with the second user.

4. The method of claim 1, the transitioning the computing environment comprising:
logging into a second user account associated with the second user, the second user account comprising at least one of an email account, a social network account, a market place, or a multimedia streaming account.

5. The method of claim 1, comprising:
identifying a communication context between the first user and the second user;
obtaining supplemental content based upon the communication context; and
providing the supplemental content through the computing environment.

6. The method of claim 5, comprising:
identifying an entity from the communication context; and
identifying at least one of an image, a textual description, search results, a video, user email information, user calendar information, or map information associated with the entity as the supplemental content.

7. The method of claim 1, the computing environment comprising a communication application shared by the first user and the second user for communication.

8. The method of claim 7, the first user experience mode corresponding to a first communication input type for the communication application, and the second user experience mode corresponding to a second communication input type for the communication application.

9. The method of claim 7, the first user experience mode corresponding to a first language for the communication application, and the second user experience mode corresponding to a second language for the communication application.

10. The method of claim 7, the transitioning the computing environment comprising:
applying the second user experience mode to the communication application in real-time during a conversation between the first user and the second user utilizing the device.

11. The method of claim 1, the transitioning the computing environment comprising:
automatically transitioning the computing environment without a first user input command from the first user and without a second user input command from the second user.

12. The method of claim 5, the computing environment comprising a communication application, and the method comprising:
creating a conversation log based upon a conversation, associated with the communication context, between the first user and the second user utilizing the communication application; and
embedding the supplemental content into the conversation log.

13. The method of claim 12, comprising:
providing access to the conversation log after termination of the conversation.

14. The method of claim 1, comprising:
responsive to detecting transfer of the device from the second user to the first user, transition the computing environment from the second user experience mode to the first user experience mode.

15. A system for transitioning between user experience modes, comprising:
a user experience transition component configured to:
apply a first user experience mode to a computing environment hosted by a device used by a first user; and
responsive to detecting transfer of the device from the first user to a second user, transition the computing environment from the first user experience mode to a second user experience mode.

16. The system of claim 15, comprising:
a supplemental content component configured to:
identify a communication context between the first user and the second user;
obtain supplemental content based upon the communication context; and
provide the supplemental content through the computing environment.

17. The system of claim 15, the computing environment comprising a communication application shared by the first user and the second user for communication, and the user experience transition component configured to:
translate a conversation, facilitated by the communication application, from a first language used by the first user to a second language used by the second user during the transition to the second user experience mode.

18. The system of claim 15, the user experience transition component configured to:
responsive to detecting transfer of the device from the second user to the first user, transition the computing environment from the second user experience mode to the first user experience mode.

19. A computer readable medium comprising instructions which when executed at least in part via a processing unit perform a method for transitioning between user experience modes, comprising:
applying a first user experience mode to a communication application hosted by a device used by a first user, the first user experience mode specifying at least one of a first language or a first communication input type associated with the first user; and
responsive to detecting transfer of the device from the first user to a second user, transitioning the communication application from the first user experience mode to a second user experience mode specifying at least one of a second language or a second communication input type associated with the second user.

20. The computer readable medium of claim 19, comprising:
identifying a communication context of a conversation between the first user and the second user through the communication application;
obtaining supplemental content based upon the communication context; and
providing the supplemental content through the communication application.
